(19) United States
(12) Patent Application Publication
(10) Pub. No.: US 2020/0374684 A1
(43) Pub. Date: Nov. 26, 2020

(54) METHOD AND DEVICE FOR ESTABLISHING SESSION

(71) Applicant: China Academy of Telecommunications Technology, Beijing (CN)

(72) Inventors: Qiang DENG, Beijing (CN); Tingfang TANG, Beijing (CN)

(21) Appl. No.: 16/957,730

(22) PCT Filed: Dec. 5, 2018
(86) PCT No.: PCT/CN2018/119418

§ 371 Date: Jun. 25, 2020

(30) Foreign Application Priority Data
Dec. 25, 2017 (CN) 201711421335.0

(51) Int. Cl. H04W 8/12; H04W 48/16; H04W 76/25; H04W 76/12; H04W 36/00

(52) U.S. Cl. CPC H04W 8/12; H04W 48/16; H04W 36/0022; H04W 76/12; H04W 76/25

(57) ABSTRACT

Disclosed are a method and device for establishing a session, used for solving the problem in the prior art that the method for establishing data transmission of a control plane in a 4G network is not applicable to a 5G network. After receiving a session establishment request sent by a terminal, an access and mobility management function entity in the embodiment of the present disclosure indicates to a session management function entity that a control plane session is established for the terminal; the session management function entity indicates tunnel information of downlink data transmission to a user plane function entity, and data transmission is performed between the access and mobility management function entity and the terminal via a non-access layer message when data needs to be transmitted.

The present is a US National Stage of International Application No. PCT/CN2018/119418, filed Dec. 5, 2018, which application claims priority to Chinese Patent Application No. 201711421335.0, filed with the Chinese Patent Office on Dec. 25, 2017 and entitled “Method and Device for Establishing Session”, which is hereby incorporated by reference in its entirety.

### FIELD

The disclosure relates to the field of communications technologies, and particularly to a method and device for establishing a session.

### BACKGROUND

In order to support the small data transmission of water meters, electricity meters, and other CIoT (Cellular Internet of Things) applications, the 3GPP (3rd Generation Partnership Project) defines a data transmission method of control plane (control plane session) in R13, where the data is transmitted between a user equipment and an MME (Mobility Management Entity) through an NAS (Non Access Stratum) message without establishing the air interface DRB (Data Radio Bearer) and S1-U connection.

Compared with the 4G network architecture, the 5G network architecture has significant changes, mainly in: (1) the network architecture based on service interfaces, there are service interfaces among the control plane network elements in the 5G core network, for example, a service interface is between the AMF (Access and Mobility Management Function) and SMF (Session Management Function); (2) the MM (Mobility Management) and SM (Session Management) are separated, where the AMF is responsible for MM function, and the SMF is responsible for SM function; (3) the CP (Control Plane) and UP (User Plane) are separated, where the User Plane Function (UPF) is the User Plane (UP) network element, and the AMF/SMF and the like are the Control Plane (CP) network elements. R15 defines the 5G basic structure and process, including the PDU Session (Protocol Data Unit Session) establishment process used to establish a user plane connection between a user equipment and a network, but the existing PDU session establishment process does not support establishing a control plane PDU (Control Plane Protocol Data Unit) session.

In summary, the method for establishing the session data transmission of the control plane in the 4G network in the prior art is not applicable to the 5G network.

### SUMMARY

The disclosure provides a method and a device for establishing a session, to solve the problem that the method for establishing the session data transmission of the control plane in the 4G network in the prior art is not applicable to the 5G network.

An embodiment of the disclosure provides a method for establishing a session, which includes:

receiving, by an access and mobility management function entity, a session establishment request sent by a user equipment;

determining, by the access and mobility management function entity, to establish a control plane session for the user equipment;

instructing, by the access and mobility management function entity, a session management function entity to establish the control plane session for the user equipment;

performing, by the access and mobility management function entity, data transmission with the user equipment through an NAS message.

An embodiment of the disclosure provides another method for establishing a session, which includes:

receiving, by a session management function entity, a session establishment request sent by a user equipment;

receiving, by the session management function entity, instruction information of establishing a control plane session for the user equipment sent by an access and mobility management function entity;

instructing, by the session management function entity, tunnel information of downlink data transmission to a user plane function entity.

An embodiment of the disclosure provides a method for establishing a session, which includes:

sending, by a user equipment, a session establishment request to an access and mobility management function entity;

establishing, by the user equipment, a control plane session with the access and mobility management function entity;

performing, by the user equipment, data transmission with the access and mobility management function entity through the control plane session.

An embodiment of the disclosure provides an access and mobility management function entity for establishing a session, which includes a processor, a memory, and a transceiver,

and the processor is configured to read a program in the memory and perform:

receiving a session establishment request sent by a user equipment; determining to establish a control plane session for the user equipment; instructing a session management function entity to establish the control plane session for the user equipment; and performing data transmission with the user equipment through an NAS message.

An embodiment of the disclosure provides a session management function entity for establishing a session, which includes a processor, a memory, and a transceiver,

and the processor is configured to read a program in the memory and perform:

receiving a session establishment request sent by a user equipment; receiving instruction information of establishing a control plane session for the user equipment sent by an access and mobility management function entity; and instructing tunnel information of downlink data transmission to a user plane function entity.

An embodiment of the disclosure provides a user equipment for establishing a session, which includes a processor, a memory, and a transceiver,

and the processor is configured to read a program in the memory and perform:

sending a session establishment request to an access and mobility management function entity;

establishing a control plane session with the access and mobility management function entity;

performing data transmission with the access and mobility management function entity through the control plane session.

An embodiment of the disclosure provides an access and mobility management function entity for establishing a session, which includes:

a first receiving device configured to receive a session establishment request sent by a user equipment;

a first execution device configured to determine to establish a control plane session for the user equipment, and instruct a session management function entity to establish the control plane session for the user equipment;

a transmission device configured to perform data transmission with the user equipment through an NAS message.

An embodiment of the disclosure provides a session management function entity for establishing a session, which includes:

a second receiving device configured to receive a session establishment request sent by a user equipment, and receive instruction information of establishing a control plane session for the user equipment sent by an access and mobility management function entity;

a second execution device configured to instruct tunnel information of downlink data transmission to a user plane function entity.

An embodiment of the disclosure provides a user equipment for establishing a session, which includes:

a sending device configured to send a session establishment request to an access and mobility management function entity;

a third execution device configured to establish a control plane session with the access and mobility management function entity;

a second transmission device configured to perform data transmission with the access and mobility management function entity through the control plane session.

An embodiment of the disclosure provides a readable storage medium for establishing a session, including the program codes that, when running on a computing device, cause the computing device to perform steps of any method of the access and mobility management function entity or steps of any method of the session management function entity or steps of any method of the user equipment.

In the embodiments of the disclosure, after receiving the session establishment request sent by the user equipment, the access and mobility management function entity instructs the session management function entity to establish the control plane session for the user equipment, and the session management function entity instructs the tunnel information of downlink data transmission to the user plane function entity. When the data needs to be transmitted, the data transmission is performed between the access and mobility management function entity and the user equipment through the NAS message. In the disclosure, when the data needs to be transmitted, the data transmission is performed between the access and mobility management function entity and the user equipment through the NAS message, so it is suitable for the transmission of the control plane data in the 5G network.

### BRIEF DESCRIPTION OF THE DRAWINGS

The embodiments of the are described in the accompanying figures.

FIG. 1 is a schematic structural diagram of a system according to an embodiment of the disclosure;

FIG. 2 is a schematic diagram of the 5G network architecture;

FIG. 3 is a schematic structural diagram of an access and mobility management function entity according to an embodiment of the disclosure;

FIG. 4 is a schematic structural diagram of a session management function entity according to an embodiment of the disclosure;

FIG. 5 is a schematic structural diagram of a user equipment according to an embodiment of the disclosure;

FIG. 6 is a schematic structural diagram of another access and mobility management function entity according to an embodiment of the disclosure;

FIG. 7 is a schematic structural diagram of another session management function entity according to an embodiment of the disclosure;

FIG. 8 is a schematic structural diagram of another user equipment according to an embodiment of the disclosure.

FIG. 9 is a schematic flow diagram of a method at the access and mobility management function entity side according to an embodiment of the disclosure;

FIG. 10 is a schematic flow diagram of a method at the session management function entity side according to an embodiment of the disclosure;

FIG. 11 is a schematic flow diagram of a method at the session user equipment side according to an embodiment of the disclosure;

FIG. 12 is a schematic diagram of a complete flow of data transmission between an access and mobility management function entity and a user equipment through a mobile session management message of non-access stratum according to an embodiment of the disclosure;

FIG. 13 is a schematic diagram of a complete process of downlink data transmission between an access and mobility management function entity and a user equipment according to an embodiment of the disclosure;

FIG. 14 is a schematic diagram of a complete flow of data transmission between an access and mobility management function entity and a user equipment through a mobile session management message of non-access stratum according to an embodiment of the disclosure; and

FIG. 15 is a schematic diagram of a complete process of downlink data transmission between an session management function entity and a user equipment according to an embodiment of the disclosure.

### DETAILED DESCRIPTION

As shown in FIG. 1, a session establishment system according to an embodiment of the disclosure includes an access and mobility management function entity 100 and a session management function entity 101.

The access and mobility management function entity 100 is configured to receive a session establishment request sent by a user equipment; determine to establish a control plane session for the user equipment; instruct the session management function entity to establish the control plane session for the user equipment; and perform the data transmission with the user equipment through a non access stratum message.

The access and mobility management function entity 101 is configured to receive a session establishment request sent by a user equipment; receive the instruction information of establishing a control plane session for the user equipment sent by the access and mobility management function entity; and instructs the tunnel information of downlink data transmission to a user plane function entity.

The user equipment 102 is configured to send a session establishment request to the access and mobility management function entity; establish a control plane session with the access and mobility management function entity; and perform the data transmission with the access and mobility management function entity through the control plane session.

In the embodiments of the disclosure, after receiving the session establishment request sent by the user equipment, the access and mobility management function entity instructs the session management function entity to establish the control plane session for the user equipment, and the session management function entity instructs the tunnel information of downlink data transmission to the user plane function entity. When the data needs to be transmitted, the data is transmitted between the access and mobility management function entity and the user equipment through the non access stratum message. In the disclosure, when the data needs to be transmitted, the data transmission is performed between the access and mobility management function entity and the user equipment through the non access stratum message, so it is suitable for the transmission of the control plane data in the 5G network.

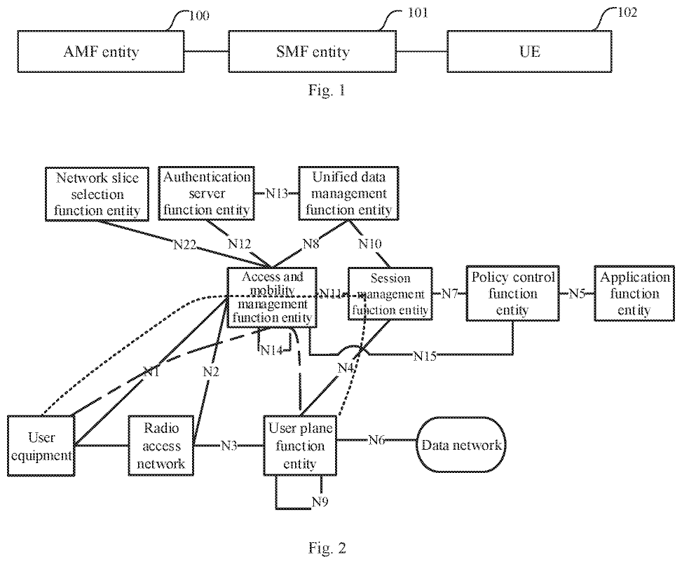

As shown in FIG. 2, based on the 5G network architecture, the embodiments of the disclosure provide two methods for establishing the data transmission of the control plane session. One method is to perform the data transmission between the access and mobility management function entity and the user equipment through NAS mobility management message, and the other method is to perform the data transmission between the access and mobility management function entity and the user equipment through NAS session management message.

1. The data transmission between the access and mobility management function entity and the user equipment through NAS mobility management message.

When the user equipment needs to establish a session, the user equipment sends a session establishment request to the access and mobility management function entity, and the session establishment request is in an NAS message.

Correspondingly, after receiving the session establishment request sent by the user equipment, the access and mobility management function entity determines a type of the session to be control plane session according to the negotiation result with the user equipment in the registration process of the user equipment, and instructs to the session management function entity to establish a control plane session for the user equipment and the tunnel information of the access and mobility management function entity.

Here, the tunnel information of the access and mobility management function entity is used by the user plane function entity to send the downlink data to the mobility management function entity.

Correspondingly, after receiving the instruction information of establishing the control plane session for the user equipment sent by the access and mobility management function entity and the tunnel information of the access and mobility management function entity, the session management function entity instructs the tunnel information, provided by the access and mobility management function entity and for the downlink data transmission, to the user plane function entity.

After the user plane function entity returns an instruction receiving response, the session management function entity instructs the service quality information of the session to the access and mobility management function entity.

Correspondingly, the access and mobility management function entity receives the service quality information of the session from the session management function entity, and the service quality information of the session includes the tunnel information of the user plane function entity.

It should be noted that the tunnel information of the user plane function entity, sent by the session management function entity to the access and mobility management function entity, may be allocated by the session management function entity itself, or may be allocated by the user plane function entity. If the tunnel information of the user plane function entity is allocated by the user plane function entity, the user plane function entity needs to put the tunnel information of the user plane function entity in the instruction receiving response to provide to the session management function entity.

The access and mobility management function entity sends an NAS access message to the user equipment, and correspondingly, the user equipment sends an NAS confirmation message to the access and mobility management function entity after receiving an NAS response message sent by the access and mobility management function entity.

In this way, the establishment of the control plane session is completed, and the data transmission is performed between the access and mobility management function entity and the user equipment through the NAS mobility management message.

If the user equipment is in the idle state, when the downlink data arrives at the user plane function entity, the session management function entity determines the type of the session to be control plane session according to the session context information of the user equipment, and instructs, to the access and mobility management function entity, the tunnel information of the user plane function entity corresponding to the session.

After receiving the tunnel information of the user plane function entity, the access and mobility management function entity sends its own tunnel information to the session management function entity, and the session management function entity forwards the tunnel information of the access and mobility management function entity to the user plane function entity. The downlink data may be sent to the access and mobility management function entity, and the access and mobility management function entity sends the downlink data to the user equipment through the NAS message.

2. The data transmission between the access and mobility management function entity and the user equipment through an NAS session management message.

When the user equipment needs to establish a session, the user equipment sends a session establishment request to the access and mobility management function entity, and the session establishment request is in the NAS message.

Correspondingly, after receiving the session establishment request sent by the user equipment, the access and mobility management function entity determines the type of the session to be control plane session according to the negotiation result with the user equipment in the registration process of the user equipment, and instructs to the session management function entity to establish a control plane session for the user equipment.

Correspondingly, after receiving the instruction information of establishing the control plane session for the user equipment sent by the access and mobility management function entity, the session management function entity instructs the tunnel information, provided by the session management function entity and for the downlink data transmission, to the user plane function entity.

Correspondingly, the access and mobility management function entity receives the service quality information of the session from the session management function entity.

It should be noted that, if the tunnel information of the user plane function entity is allocated by the user plane function entity, the user plane function entity needs to provide the tunnel information of the user plane function entity to the session management function entity.

Correspondingly, after the control plane session is established, the data transmission is performed between the access and mobility management function entity and the user equipment through the NAS session management message, and the data transmission is performed between the access and mobility management function entity and the user plane function entity through the tunnel information.

The access and mobility management function entity sends an NAS access message to the user equipment, and correspondingly, the user equipment sends an NAS confirmation message to the access and mobility management function entity after receiving an NAS response message sent by the access and mobility management function entity.

In this way, the establishment of the control plane session is completed, the data transmission is performed between the access and mobility management function entity and the user equipment through the NAS session management message, and the transmission of the NAS session management message is performed between the access and mobility management function entity and the session management function entity.

If the user equipment is in the idle state, when the downlink data arrives at the user plane function entity, the session management function entity determines the type of the session to be control plane session according to the session context information of the user equipment, and instructs the tunnel information of the session management function entity to the user plane function entity. The downlink data may be sent to the session management function entity.

The session management function entity sends the downlink data to the access and mobility management function entity, and the access and mobility management function entity sends the downlink data to the user equipment through the NAS message.

The following embodiments of the disclosure describe the two methods for establishing the data transmission of the control plane session described above in detail.

1. The data transmission between the access and mobility management function entity and the user equipment through an NAS session management message.

The user equipment sends, to the access and mobility management function entity, an NAS request for establishing a PDU session, and the NAS request includes an ID (identification) used to establish the PDU session and allocated by the user equipment and the PDU session establishment request.

Correspondingly, after receiving the NAS request from the user equipment, the access and mobility management function entity determines that the NAS request is a message of creating a new PDU session, judges whether a control plane session needs to be established for the user equipment according the negotiation result with the user equipment in the user equipment registration process, and establishes a control plane session for the user equipment if the negotiation result is Control Plane CIoT EPS optimization.

After the access and mobility management function determines to establish the control plane session for the user equipment, a request service message of the session management function is sent to the session management function entity.

Here, the request service message of the session management function includes the ID of the access and mobility management function, the ID used to establish a PDU session, the PDU session establishment request, the instruction information for establishing a control plane session, and the tunnel information of the access and mobility management function entity, the tunnel information the access and mobility management function entity is used by the user plane function entity to send the downlink data to the access and mobility management function entity.

Correspondingly, after receiving the request service message of the session management function, the session management function entity requests a UDM (Unified Data Management) service and obtains the relevant subscription information of the PDU session from the UDM entity; and the session management function entity requests a PCF (Policy Control Function) service and obtains the relevant PCC rule of the PDU session from the PCF.

After obtaining the relevant subscription information and relevant PCC rule of the PDU session, the session management function entity puts the tunnel information of the access and mobility management function entity and the packet detection and other rules in an N4 session establishment request and sends to the selected user plane function entity.

After receiving an N4 session establishment response sent by the user plane function entity, the session management function entity put the tunnel information of the user plane function entity, the PDU session ID and the PDU session establishment response in the service quality information of the session to send to the access and mobility management function entity, and the tunnel information of the user plane function entity is used by the access and mobility management function entity to send the uplink data to the user plane function entity.

The access and mobility management function entity needs to perform the QoS (Quality of Service) configuration when establishing the session, but the access and mobility management function entity has not known the configuration parameters of the QoS configuration, which need to be provided by the session management function entity, so the session establishment response further includes the configuration parameters of the QoS configuration.

Correspondingly, the access and mobility management function entity sends an N2 request message to an RAN (Radio Access Network), and the N2 request message includes the NAS message (i.e., the PDU session ID and the PDU session establishment response).

After receiving the N2 request message sent by the access and mobility management function entity, the RAN sends the NAS message in the N2 request message to the user equipment through an RRC message.

After receiving the NAS message (information) sent by the RAN, the user equipment entity returns a NAS message of the PDU session establishment response to the RAN through an RRC (Radio Resource Control) message, and in this way, the user equipment completes the establishment of the control plane session.

Correspondingly, after the control plane session is established, the data transmission is performed between the access and mobility management function entity and the user equipment through the NAS mobility management message.

1). The user equipment is in the idle state, and when the downlink data arrives at the user plane function entity.

When the user plane function of the user plane function entity finds no path for sending the downlink data, the user plane function entity sends a data notification request to the session management function entity, where this notification request includes the PDU session ID.

Correspondingly, after receiving the data notification request, the session management function entity determines the type of the session to be control plane session according to the session context information of the user equipment, and sends the service request message of the access and mobility management function entity to the access and mobility management function entity, and the service request message of the access and mobility management function entity includes the PDU session ID and the tunnel information of the user plane function entity.

Correspondingly, after receiving the service request message of the access and mobility management function, the access and mobility management function entity puts the tunnel information of the access and mobility management function entity in the service request message of the session management function entity and sends to the session management function entity.

After receiving the tunnel information of the access and mobility management function entity sent by the access and mobility management function entity, the session management function entity sends the tunnel information of the access and mobility management function entity to the user plane function entity through a downlink data message of N4 session.

Correspondingly, the user plane function entity sends the received downlink data to the access and mobility management function entity through the tunnel information of the access and mobility management function entity, and the access and mobility management function entity sends a paging to the user equipment through the RAN after receiving the downlink data sent by the user plane function entity.

The user equipment sends a control plane session request to the RAN through an RRC message after receiving the paging sent from the RAN, the RAN sends the control plane session request to the access and mobility management function entity, and a connection is established between the user equipment and the access and mobility management function entity.

Correspondingly, the access and mobility management function entity performs data encryption and integrity protection on the downlink data, and sends the downlink data to the user equipment.

It should be noted here that, the step in which the access and mobility management function entity sends the service request message of the session management function entity to the session management function entity and the step in which the user plane function entity sends the received downlink data to the access and mobility management function entity through the tunnel information of the access and mobility management function entity may be performed after the connection is established between the user equipment and the access and mobility management function entity.

2. When the tunnel information for sending the downlink data is the tunnel information of the access and mobility management function entity.

The user equipment sends the NAS request of establishing a PDU session to the access and mobility management function entity, and the NAS request includes an ID used to establish the PDU session and allocated by the user equipment and the PDU session establishment request.

Correspondingly, after receiving the NAS request from the user equipment, the access and mobility management function entity determines the NAS request is a message of creating a new PDU session, judges whether a control plane session needs to be established for the user equipment according the negotiation result with the user equipment in the user equipment registration process, and establishes a control plane session for the user equipment if the negotiation result is Control Plane CIoT EPS optimization.

After the access and mobility management function determines to establish a control plane session for the user equipment, the access and mobility management function entity sends a request service message of the session management function to the session management function entity, and the request service message of the session management function entity includes the ID of the access and mobility management function, the ID used to establish a PDU session, the PDU session establishment request, and the instruction information of establishing a control plane session.

Correspondingly, after receiving the request service message of the session management function, the session management function entity requests a UDM service and obtains the relevant subscription information of the PDU session from the UDM entity; and the session management function entity requests a PCF service and obtains the relevant PCC rule of the PDU session from the PCF.

After obtaining the relevant subscription information and relevant PCC rule of the PDU session, the session management function entity puts the tunnel information of the access and mobility management function entity and the packet detection and other rules in the establishment request of N4 session for sending to the selected user plane function entity.

After the session management function entity receives the establishment response of N4 session sent by the user plane function entity, the PDU session ID and the establishment response of the PDU session are put in the request service response of the access and mobility management function to be sent to the access and mobility management function entity.

Correspondingly, the access and mobility management function entity sends an N2 request to the RAN, and the N2 request includes the NAS message (i.e., the PDU session ID and the establishment response of the PDU session).

After receiving the N2 request sent by the access and mobility management function entity, the RAN sends the NAS message in the N2 request to the user equipment through an RRC message.

After receiving the NAS message sent by the RAN, the user equipment entity returns an NAS response of establishing a PDU session to the RAN through an RRC message, and in this way, the establishment of the control plane session is completed.

When the control plane of the user plane function entity needs to send the data to the user equipment, the user plane function entity sends the data to the access and mobility management function entity through the tunnel information of the access and mobility management function entity, and the access and mobility management function entity sends the data to the user equipment.

1). The user equipment is in the idle state, and when the downlink data arrives at the user plane function entity.

When the user plane function of the user plane function entity finds no downlink data path, the user plane function entity sends a data notification request to the session management function entity, where this notification request includes the PDU session ID.

Correspondingly, after receiving the data notification request, the session management function entity determines the session type to be control plane session according to the session context information of the user equipment, and sends the tunnel information of the access and mobility management function entity to the user plane function entity through the downlink data of the N4 session.

Correspondingly, after receiving the service request message of the access and mobility management function, the access and mobility management function entity puts the tunnel information of the access and mobility management function entity in the service request message of the access and mobility management function entity and sends to the session management function entity.

After receiving the tunnel information of the access and mobility management function entity sent by the access and mobility management function entity, the session management function entity sends the tunnel information of the access and mobility management function entity to the user plane function entity.

Correspondingly, after receiving the downlink data sent by the user plane function entity through the tunnel information of the access and mobility management function entity, the access and mobility management function entity puts the downlink data in the service request of the access and mobility management function entity and sends to the access and mobility management function entity.

After receiving the downlink data sent by the user plane function entity, the access and mobility management function entity sends a paging to the user equipment through the RNA.

The user equipment sends a control plane session request to the RNA through an RRC message after receiving the paging sent from the RNA, the RNA sends the control plane session request to the access and mobility management function entity, and a connection is established between the user equipment and the access and mobility management function entity.

Correspondingly, the access and mobility management function entity encrypts the received downlink data and protects its integrity, and sends the downlink data to the user equipment.

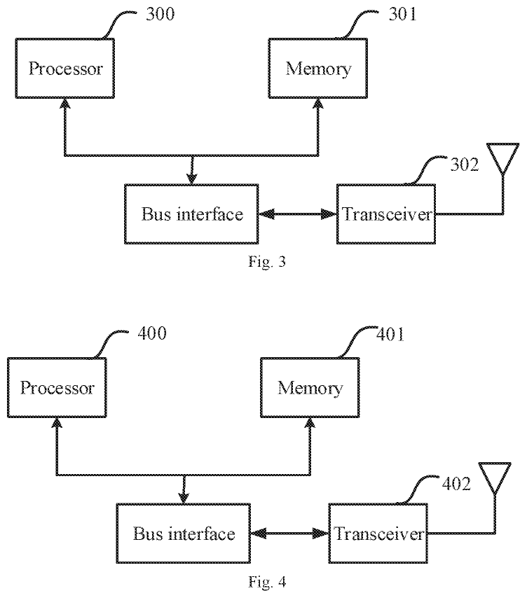

As shown in FIG. 3, an embodiment of the disclosure provides an access and mobility management function entity for establishing a session, which includes a processor 300, a memory 301, and a transceiver 302.

The processor 300 is configured to read the program in the memory 301 and perform: receiving a session establishment request sent by a user equipment; determining to establish a control plane session for the user equipment; instructing a session management function entity to establish the control plane session for the user equipment; and performing the data transmission with the user equipment through an NAS message.

In one embodiment, the processor 300 is configured to: negotiate with the user equipment to determine the session type to be control plane session in the registration process.

In one embodiment, the processor 300 is further configured to: instruct the tunnel information of the access and mobility management function entity to the session management function entity.

In one embodiment, the tunnel information of the access and mobility management function entity is used by a user plane function entity to send the downlink data to the access and mobility management function entity.

In one embodiment, the processor 300 is further configured to: receive the tunnel information of the user plane function entity instructed by the session management function entity.

In one embodiment, the tunnel information of the user plane function entity is used by the access and mobility management function entity to send the uplink data to the user plane function entity.

In one embodiment, the processor 300 is further configured to: receive the service quality information of the session instructed by the session management function entity.

In one embodiment, the processor 300 is configured to: perform the data transmission with the user equipment through an NAS mobility management message.

In one embodiment, the processor 300 is further configured to: perform the data transmission with the user plane function entity through the tunnel information.

In one embodiment, the processor 300 is configured to: perform the data transmission with the user equipment through an NAS session management message.

In one embodiment, the processor 300 is further configured to: perform the transmission of the NAS session management message with the session management function entity.

The processor 300 is responsible for managing the bus architecture and general processing, and the memory 301 may store the data used by the processor 300 when performing the operations. The transceiver 302 is configured to receive and send the data under the control of the processor 300.

The bus architecture may include any numbers of interconnected buses and bridges, and specifically link various circuits of one or more processors represented by the processor 300 and the memory represented by the memory 301. The bus architecture may further link various other circuits such as peripheral device, voltage regulator and power management circuit, which are all well known in the art and thus will not be further described again herein. The bus interface provides an interface. The processor 300 is responsible for managing the bus architecture and general processing, and the memory 301 may store the data used by the processor 300 when performing the operations.

The procedure disclosed by the embodiment of the disclosure may be applied in the processor 300 or implemented by the processor 300. In the implementation process, each step of the signal processing flow may be completed by the integrated logic circuit of hardware in the processor 300 or the instruction in the form of software. The processor 300 may be a general-purpose processor, a digital signal processor, an application specific integrated circuit, a field programmable gate array or other programmable logic device, a discrete gate or transistor logic device, or a discrete hardware component, and may implement or perform each method, step and logical block diagram disclosed in the embodiments of the disclosure. The general-purpose processor may be a microprocessor or any conventional processor or the like. The steps of the method disclosed in combination with the embodiments of the disclosure may be directly completed by a hardware processor, or completed by a combination of hardware and software devices in the processor. The software devices may be located in the random access memory, flash memory, read only memory, programmable read only memory or electrically erasable programmable read only memory, register and other mature storage medium in the art. The storage medium is located in the memory 301, and the processor 300 reads the information in the memory 301 and completes the steps of the signal processing flow in combination with its hardware.

As shown in FIG. 4, an embodiment of the disclosure provides a session management function entity for establishing a session, which includes a processor 400, a memory 401, and a transceiver 402.

The processor 400 is configured to read the program in the memory 401 and perform: receiving a session establishment request sent by a user equipment; receiving the instruction information of establishing a control plane session for the user equipment sent by an access and mobility management function entity; and instructing the tunnel information of downlink data transmission to a user plane function entity.

In one embodiment, the processor 400 is further configured to: receive the tunnel information of the access and mobility management function entity sent by the access and mobility management function entity.

In one embodiment, the tunnel information of downlink data transmission is the tunnel information of the access and mobility management function entity, or the tunnel information of the session management function entity.

In one embodiment, the processor 400 is further configured to: instruct the service quality information of the session to the access and mobility management function entity.

In one embodiment, the processor is further configured to: instruct the tunnel information of the user plane function entity to the access and mobility management function entity.

In one embodiment, the processor 400 is further configured to: determine the session type to be control plane session according to the session context information of the user equipment.

In one embodiment, the processor 400 is configured to: instruct the tunnel information of the user plane function entity corresponding to the session to the access and mobility management function entity.

In one embodiment, the processor 400 is configured to: perform the data transmission with the user equipment through an NAS session management message.

In one embodiment, the processor 400 is further configured to: perform the data transmission with the user plane function entity through the tunnel information.

The bus architecture may include any numbers of interconnected buses and bridges, and specifically link various circuits of one or more processors represented by the processor 400 and the memory represented by the memory 401. The bus architecture may further link various other circuits such as peripheral device, voltage regulator and power management circuit, which are all well known in the art and thus will not be further described again herein. The bus interface provides an interface. The processor 400 is responsible for managing the bus architecture and general processing, and the memory 401 may store the data used by the processor 400 when performing the operations.

The procedure disclosed by the embodiment of the disclosure may be applied in the processor 400 or implemented by the processor 400. In the implementation process, each step of the signal processing flow may be completed by the integrated logic circuit of hardware in the processor 400 or the instruction in the form of software. The processor 400 may be a general-purpose processor, a digital signal processor, an application specific integrated circuit, a field programmable gate array or other programmable logic device, a discrete gate or transistor logic device, or a discrete hardware component, and may implement or perform each method, step and logical block diagram disclosed in the embodiments of the disclosure. The general-purpose processor may be a microprocessor or any conventional processor or the like. The steps of the method disclosed in combination with the embodiments of the disclosure may be directly completed by a hardware processor, or completed by a combination of hardware and software devices in the processor. The software devices may be located in the random access memory, flash memory, read only memory, programmable read only memory or electrically erasable programmable read only memory, register and other mature storage medium in the art. The storage medium is located in the memory 401, and the processor 400 reads the information in the memory 401 and completes the steps of the signal processing flow in combination with its hardware.

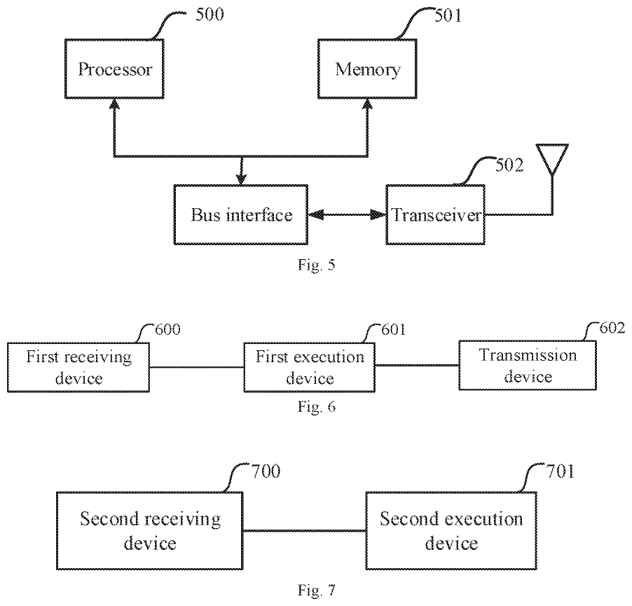

As shown in FIG. 5, an embodiment of the disclosure provides a user equipment for establishing a session. The user equipment includes a processor 500, a memory 501 and a transceiver 502, and the processor 500 is configured to read the program in the memory and perform: sending a session establishment request to an access and mobility management function entity; establishing a control plane session with the access and mobility management function entity; and performing the data transmission with the access and mobility management function entity through the control plane session.

In one embodiment, the processor 500 is configured to: negotiate with the access and mobility management function entity to determine the session type to be control plane session in the registration process before sending the session establishment request to the access and mobility management function entity.

In one embodiment, the processor 500 is configured to: send an NAS confirmation message to the access and mobility management function entity after receiving an NAS response message sent by the access and mobility management function entity.

In one embodiment, the processor 500 is configured to: perform the data transmission with the access and mobility management function entity through an NAS mobility management message.

In one embodiment, the processor 500 is configured to: perform the data transmission with the access and mobility management function entity through an NAS session management message.

The bus architecture may include any numbers of interconnected buses and bridges, and specifically link various circuits of one or more processors represented by the processor 500 and the memory represented by the memory 501. The bus architecture may further link various other circuits such as peripheral device, voltage regulator and power management circuit, which are all well known in the art and thus will not be further described again herein. The bus interface provides an interface. The processor 500 is responsible for managing the bus architecture and general processing, and the memory 501 may store the data used by the processor 500 when performing the operations.

The procedure disclosed by the embodiment of the disclosure may be applied in the processor 500 or implemented by the processor 500. In the implementation process, each step of the signal processing flow may be completed by the integrated logic circuit of hardware in the processor 500 or the instruction in the form of software. The processor 500 may be a general-purpose processor, a digital signal processor, an application specific integrated circuit, a field programmable gate array or other programmable logic device, a discrete gate or transistor logic device, or a discrete hardware component, and may implement or perform each method, step and logical block diagram disclosed in the embodiments of the disclosure. The general-purpose processor may be a microprocessor or any conventional processor or the like. The steps of the method disclosed in combination with the embodiments of the disclosure may be directly completed by a hardware processor, or completed by a combination of hardware and software devices in the processor. The software devices may be located in the random access memory, flash memory, read only memory, programmable read only memory or electrically erasable programmable read only memory, register and other mature storage medium in the art. The storage medium is located in the memory 501, and the processor 500 reads the information in the memory 501 and completes the steps of the signal processing flow in combination with its hardware.

As shown in FIG. 6, an embodiment of the disclosure provides an access and mobility management function entity for establishing a session, which includes: a first receiving device 600 configured to receive a session establishment request sent by a user equipment; a first execution device 601 configured to determine to establish a control plane session for the user equipment, and instruct a session management function entity to establish the control plane session for the user equipment; and a transmission device 602 configured to perform the data transmission with the user equipment through an NAS message.

In one embodiment, the first execution device 601 is further configured to: negotiate with the user equipment to determine the session type to be control plane session in the registration process.

In one embodiment, the first execution device 601 is further configured to: instruct the tunnel information of the access and mobility management function entity to the session management function entity.

In one embodiment, the tunnel information of the access and mobility management function entity is used by a user plane function entity to send the downlink data to the access and mobility management function entity.

In one embodiment, the first receiving device 600 is further configured to: receive the tunnel information of the user plane function entity instructed by the session management function entity.

In one embodiment, the tunnel information of the user plane function entity is used by the access and mobility management function entity to send the uplink data to the user plane function entity.

In one embodiment, the first receiving device 600 is further configured to: receive the service quality information of the session instructed by the session management function entity.

In one embodiment, the transmission device 602 is configured to: perform the data transmission with the user equipment through an NAS mobility management message.

In one embodiment, the transmission device 602 is further configured to: perform the data transmission with the user plane function entity through the tunnel information.

In one embodiment, the transmission device 602 is configured to: perform the data transmission with the user equipment through an NAS session management message.

In one embodiment, the transmission device 602 is further configured to: perform the transmission of the NAS session management message with the session management function entity.

As shown in FIG. 7, an embodiment of the disclosure provides a session management function entity for establishing a session, which includes: a second receiving device 700 configured to receive a session establishment request sent by a user equipment, and receive the instruction information of establishing a control plane session for the user equipment sent by an access and mobility management function entity; and a second execution device 701 configured to instruct the tunnel information of downlink data transmission to a user plane function entity.

In one embodiment, the second receiving device 700 is further configured to: receive the tunnel information of the access and mobility management function entity sent by the access and mobility management function entity.

In one embodiment, the tunnel information of downlink data transmission is the tunnel information of the access and mobility management function entity, or the tunnel information of the session management function entity.

In one embodiment, the second execution device 701 is further configured to: instruct the service quality information of the session to the access and mobility management function entity.

In one embodiment, the second execution device 701 is further configured to: instruct the tunnel information of the user plane function entity to the access and mobility management function entity.

In one embodiment, the second execution device 701 is further configured to: determine the session type to be control plane session according to the session context information of the user equipment.

In one embodiment, the second execution device 701 is further configured to: instruct the tunnel information of the user plane function entity corresponding to the session to the access and mobility management function entity.

In one embodiment, the second execution device 701 is further configured to: perform the data transmission with the user equipment through an NAS session management message.

In one embodiment, the second execution device 701 is further configured to: perform the data transmission with the user plane function entity through the tunnel information.

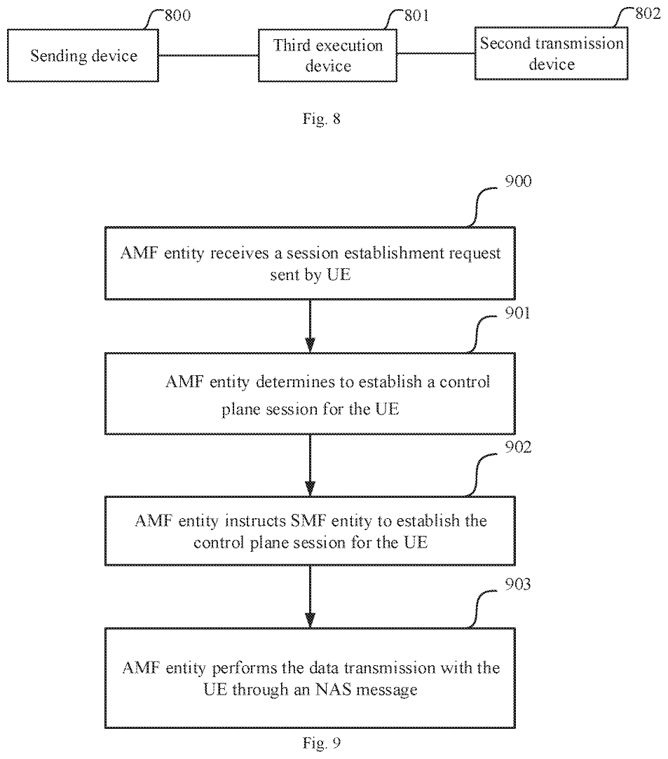

As shown in FIG. 8, an embodiment of the disclosure provides a user equipment for establishing a session, which includes: a sending device 800 configured to send a session establishment request to an access and mobility management function entity; a third execution device 801 configured to establish a control plane session with the access and mobility management function entity; and a second transmission device 802 configured to perform the data transmission with the access and mobility management function entity through the control plane session.

In one embodiment, the third execution device 801 is configured to: negotiate with the access and mobility management function entity to determine the session type to be control plane session in the registration process before sending the session establishment request message to the access and mobility management function entity.

In one embodiment, the sending device 800 is configured to: send an NAS confirmation message to the access and mobility management function entity after receiving an NAS response message sent by the access and mobility management function entity.

In one embodiment, the second transmission device 802 is configured to: perform the data transmission with the access and mobility management function entity through an NAS mobility management message.

In one embodiment, the second transmission device 802 is configured to: perform the data transmission with the access and mobility management function entity through an NAS session management message.

An embodiment of the disclosure provides a readable storage medium for establishing a session, including the program codes which are configured, when running on a computing device, to cause the computing device to perform steps of any method of the access and mobility management function entity or steps of any method of the session management function entity or steps of any method of the user equipment.

Based upon the same inventive concept, an embodiment of the disclosure further provides a method of the access and mobility management function entity for establishing the session. Since the device corresponding to this method is the access and mobility management function entity in the session establishment system in the embodiments of the disclosure, and the principle solving the problem of this method is similar to that of the device, the implementations of this method may refer to the implementations of the device, and the repeated description thereof will be omitted here.

As shown in FIG. 9, an embodiment of the disclosure provides a method of establishing the session by the access and mobility management function entity. The method includes the following steps.

Step 900: an access and mobility management function entity receives a session establishment request sent by a user equipment.

Step 901: the access and mobility management function entity determines to establish a control plane session for the user equipment.

Step 902: the access and mobility management function entity instructs a session management function entity to establish the control plane session for the user equipment.

Step 903: the access and mobility management function entity performs the data transmission with the user equipment through an NAS message.

In one embodiment, the access and mobility management function entity determining to establish a control plane session for the user equipment includes: the access and mobility management function entity determining the session type to be control plane session by negotiating with the user equipment in the registration process.

In one embodiment, the access and mobility management function entity instructs a session management function entity to establish the control plane session for the user equipment, and the method further includes:

the access and mobility management function entity instructs the tunnel information of the access and mobility management function entity to the session management function entity.

In one embodiment, the access and mobility management function entity instructing the tunnel information of the access and mobility management function entity to the session management function entity includes: the tunnel information of the access and mobility management function entity is used by a user plane function entity to send the downlink data to the access and mobility management function entity.

In one embodiment, the access and mobility management function entity instructs a session management function entity to establish the control plane session for the user equipment, and the method further includes:

the access and mobility management function entity receives the tunnel information of the user plane function entity instructed by the session management function entity.

In one embodiment, the tunnel information of the user plane function entity is used by the access and mobility management function entity to send the uplink data to the user plane function entity.

In one embodiment, the access and mobility management function entity receives the tunnel information of a user plane function entity instructed by the session management function entity, and the method further includes:

the access and mobility management function entity receives the service quality information of the session instructed by the session management function entity.

In one embodiment, the access and mobility management function entity performing the data transmission with the user equipment through an NAS message includes: the access and mobility management function entity performs the data transmission with the user equipment through an NAS mobility management message.

In one embodiment, the access and mobility management function entity performs the data transmission with the user equipment through an NAS mobility management message, and the method further includes: the access and mobility management function entity performs the data transmission with the user plane function entity through the tunnel information.

In one embodiment, the access and mobility management function entity performs the data transmission with the user equipment through an NAS message, including: the access and mobility management function entity performs the data transmission with the user equipment through an NAS session management message.

In one embodiment, the access and mobility management function entity performs the data transmission with the user equipment through an NAS session management message, and the method further includes: the access and mobility management function entity performs the transmission of the NAS session management message with the session management function entity.

Based upon the same inventive concept, an embodiment of the disclosure further provides a method of the session management function entity for establishing the session. Since the device corresponding to this method is the session management function entity in the session establishment system in the embodiments of the disclosure, and the principle solving the problem of this method is similar to that of the device, the implementations of this method may refer to the implementations of the device, and the repeated description thereof will be omitted here.

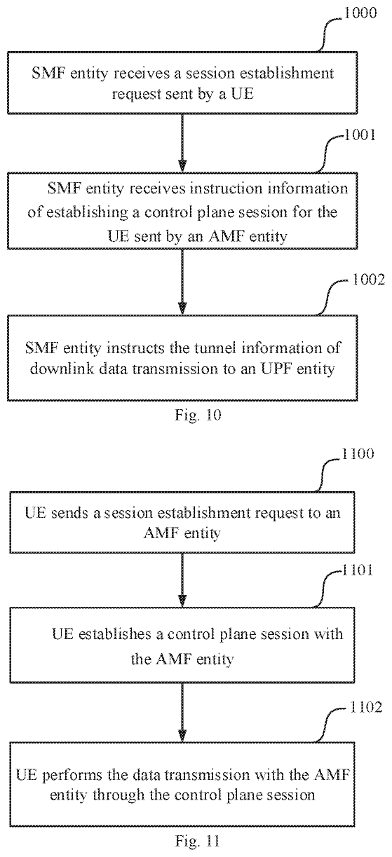

As shown in FIG. 10, an embodiment of the disclosure provides a method of the session management function entity for establishing the session.

Step 1000: a session management function entity receives a session establishment request sent by a user equipment.

Step 1001: the session management function entity receives the instruction information of establishing a control plane session for the user equipment sent by an access and mobility management function entity.

Step 1002: the session management function entity instructs the tunnel information of downlink data transmission to a user plane function entity.

In one embodiment, the session management function entity receives the instruction information of establishing a control plane session for the user equipment sent by an access and mobility management function entity, and the method further includes:

the session management function entity receives the tunnel information of the access and mobility management function entity sent by the access and mobility management function entity.

In one embodiment, the session management function entity instructs the tunnel information of downlink data transmission to a user plane function entity, including: the tunnel information of downlink data transmission is the tunnel information of the access and mobility management function entity, or the tunnel information of the session management function entity.

In one embodiment, the session management function entity receives the instruction information of establishing a control plane session for the user equipment sent by an access and mobility management function entity, and the method further includes: the session management function entity instructs the service quality information of the session to the access and mobility management function entity.

In one embodiment, the session management function entity receives the instruction information of establishing a control plane session for the user equipment sent by an access and mobility management function entity, and the method further includes: the session management function entity instructs the tunnel information of the user plane function entity to the access and mobility management function entity.

In one embodiment, the session management function entity receives the instruction information of establishing a control plane session for the user equipment sent by an access and mobility management function entity, and the method further includes: the session management function entity determines the session type to be control plane session according to the session context information of the user equipment.

In one embodiment, the session management function entity determines the session type to be control plane session, and the method further includes:

the session management function entity instructs the tunnel information of the user plane function entity corresponding to the session to the access and mobility management function entity.

In one embodiment, the session management function entity receives the instruction information of establishing a control plane session for the user equipment sent by an access and mobility management function entity, and the method further includes:

the session management function entity performs the data transmission with the user equipment through an NAS session management message.

In one embodiment, the session management function entity performs the data transmission with the user equipment through the NAS session management message, and the method further includes:

the session management function entity performs the data transmission with the user plane function entity through the tunnel information.

Based upon the same inventive concept, an embodiment of the disclosure further provides a method of the user equipment for establishing the session. Since the device corresponding to this method is the user equipment in the session establishment system in the embodiments of the disclosure, and the principle solving the problem of this method is similar to that of the device, the implementations of this method may refer to the implementations of the device, and the repeated description thereof will be omitted here.

As shown in FIG. 11, an embodiment of the disclosure provides a method of the user equipment for establishing the session.

Step 1100: a user equipment sends a session establishment request to an access and mobility management function entity.

Step 1101: the user equipment establishes a control plane session with the access and mobility management function entity.

Step 1102: the user equipment performs the data transmission with the access and mobility management function entity through the control plane session.

In one embodiment, before the user equipment sends the session establishment request to the access and mobility management function entity, the method includes:

the user equipment negotiates with the access and mobility management function entity to determine the session type to be control plane session in the registration process.

In one embodiment, the user equipment establishes a control plane session with the access and mobility management function entity, including:

the user equipment sends an NAS confirmation message to the access and mobility management function entity after receiving an NAS response message sent by the access and mobility management function entity.

In one embodiment, the user equipment performs the data transmission with the access and mobility management function entity through the control plane session, including:

the user equipment performs the data transmission with the access and mobility management function entity through an NAS mobility management message.

In one embodiment, the user equipment performs the data transmission with the access and mobility management function entity through the control plane session, including:

the user equipment performs the data transmission with the access and mobility management function entity through an NAS session management message.

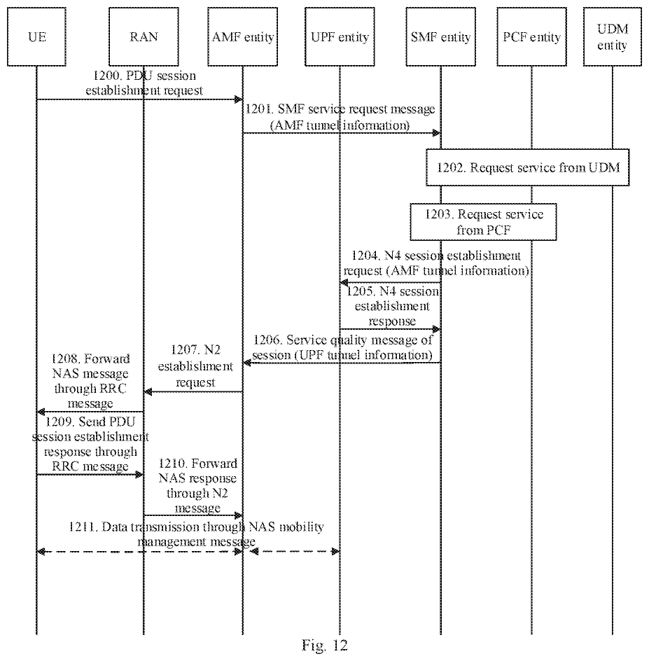

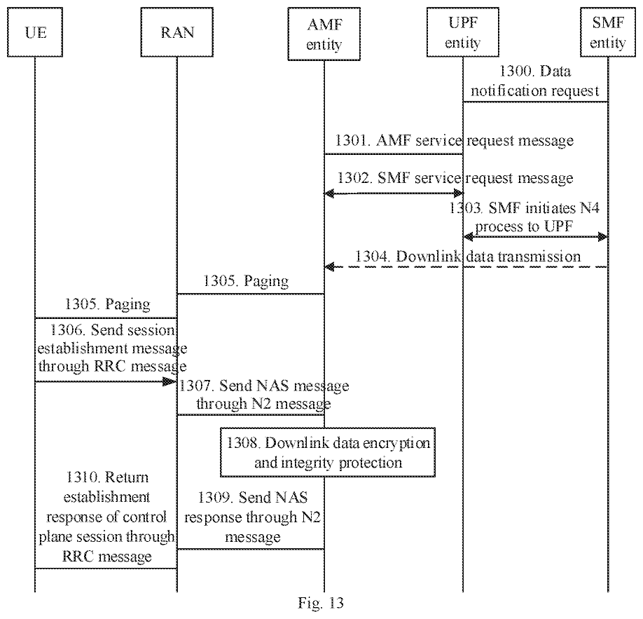

As shown in FIG. 12, an embodiment of the disclosure provides a complete flow chart of performing the data transmission between an access and mobility management function entity and a user equipment through an NAS mobility management message (in the following, the access and mobility management function entity is the AMF entity, the SMF entity is the session management function entity, and the UPF entity is the user plane function entity).

Step 1200: the user equipment sends a PDU session establishment request to the AMF entity.

Step 1201: the AMF entity sends a service request message of the session management function (including the AMF tunnel information) (Nsmf_PDUSession_CreateSMRequest) to the session management function entity.

Step 1202: the SMF entity requests the service from the UDM.

Step 1203: the SMF entity requests the service from the PCF.

Step 1204: the SMF entity sends an N4 session establishment request (including the AMF tunnel information) (N4 Session Establishment) to the UPF entity.

Step 1205: the UPF entity returns an N4 session establishment response (N4 Session Estbl Resp) to the SMF entity.

Step 1206: the SMF entity returns the quality service message of the session (including the UPF tunnel information) (Nsmf_PDUSession_CreateSMContextResp) to the AMF entity.

Step 1207: the AMF entity sends an N2 establishment request (N2 msg) to the RAN entity.

Step 1208: the RAN entity forwards an NAS message to the user equipment through an RRC message (RRC msg).

Step 1209: the user equipment sends a PDU session establishment response to the RAN through an RRC message (RRC msg).

Step 1210: the RAN entity forwards an NAS response to the AMF entity through an N2 message (N2 msg).

Step 1211: perform the data transmission between the AMF and the user equipment through an NAS mobility management message after the establishment of the PDU session is completed.

As shown in FIG. 13, an embodiment of the disclosure provides a complete flow chart of performing the downlink data transmission between an access and mobility management function entity and a user equipment (in the following, the access and mobility management function entity is the AMF entity, the SMF entity is the session management function entity, and the UPF entity is the user plane function entity).

Step 1300: the UPF entity sends a data notification request (Data Notification) to the SMF entity.

Step 1301: the SMF entity sends an AMF service request message.

Step 1302: the AMF entity passes an SMF service request message.

Step 1303: the SMF entity initiates an N4 process (N4 Session Update) to the UPF entity.

Step 1304: the UPF entity sends the downlink data to the AMF (N4 Session Update).

Step 1305: the AMF entity initiates a paging (Paging) to the user equipment.

Step 1306: the user equipment sends a session establishment message to the RAN through an RRC message (RRC msg).

Step 1307: the RAN entity sends an NAS message to the AMF entity through an N2 message (N2 msg).

Step 1308: the AMF entity performs encryption and integrity protection on the downlink data.

Step 1309: the AMF entity sends an NAS response message (NAS msg) to the RAN entity through an N2 message.

Step 1310: the RAN entity returns an establishment response message of the control plane session to the user equipment through an RRC message (RRC Msg).

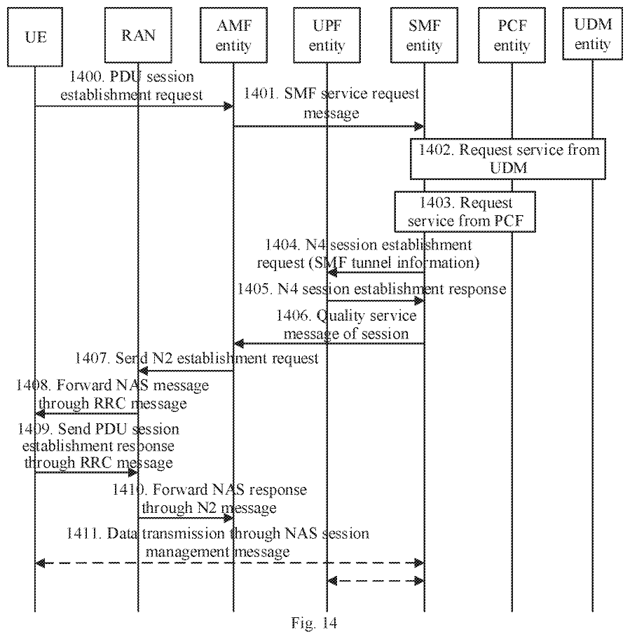

As shown in FIG. 14, an embodiment of the disclosure provides a complete flow chart of performing the data transmission between an access and mobility management function entity and a user equipment through an NAS session management message (in the following, the access and mobility management function entity is the AMF entity, the SMF entity is the session management function entity, and the UPF entity is the user plane function entity).

Step 1400: the user equipment sends a PDU session establishment request to the AMF entity.

Step 1401: the AMF entity sends an SMF service request message (Nsmf_PDUSession_CreateSMRequest) to the SMF entity.

Step 1402: the SMF entity requests the service from the UDM.

Step 1403: the SMF entity requests the service from the PCF.

Step 1404: the SMF entity sends an N4 session establishment request (N4 Session Establishment (SMF tunnel information)) to the UPF entity.

Step 1405: the UPF entity returns an N4 session establishment response (N4 Session Estbl Resp) to the SMF entity.

Step 1406: the SMF entity sends the quality service message of the session (Nsmf_PDUSession_CreateSMContextResp) to the AMF entity.

Step 1407: the AMF entity sends an N2 establishment request (N2 msg) to the RNA entity.

Step 1408: the RAN entity forwards an NAS message to the user equipment through an RRC message (RRC msg).

Step 1409: the user equipment sends a PDU session establishment response to the RAN through an RRC message (RRC msg).

Step 1410: the RAN entity forwards an NAS response to the AMF entity through an N2 message (N2 msg).

Step 1411: perform the data transmission between the AMF and the user equipment through an NAS session management message after the establishment of the PDU session is completed.

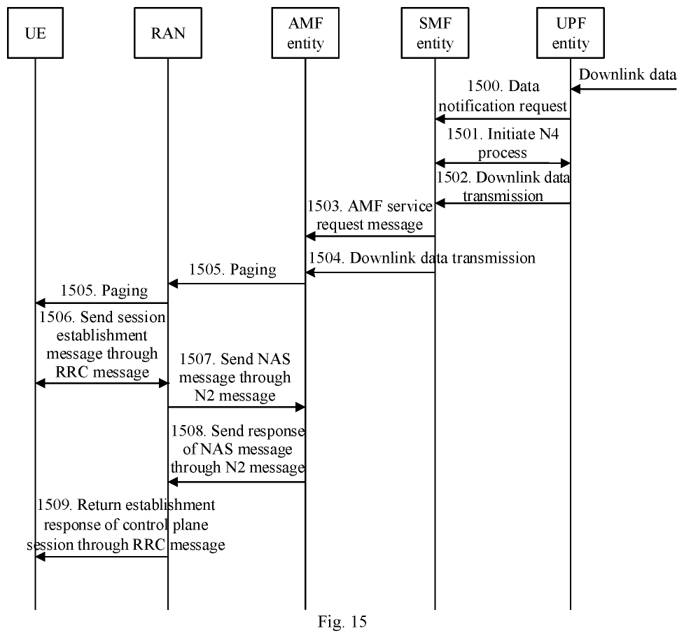

As shown in FIG. 15, an embodiment of the disclosure provides a complete flow chart of performing the downlink data transmission among an access and mobility management function entity, a session management function entity and a user equipment (in the following, the access and mobility management function entity is the AMF entity, the SMF entity is the session management function entity, and the UPF entity is the user plane function entity).

Step 1500: the UPF entity sends a data notification request (Data Notification) to the SMF entity.

Step 1501: the SMF entity initiates an N4 process (N4 Session Update) to the UPF entity.

Step 1502: the UPF entity sends the downlink data (DL data) to the SMF entity.

Step 1503: the SMF entity sends an AMF service request message (Nsmf_DataTransReq/Resp (N1 SM)).

Step 1504: the SMF entity sends the downlink data (DL data) to the AMF entity.

Step 1505: the AMF entity initiates a paging (Paging) to the user equipment.

Step 1506: the user equipment sends a session establishment message to the RAN through an RRC message (RRC msg).

Step 1507: the RAN entity sends an NAS message to the AMF entity through an N2 message (N2 msg).

Step 1508: the AMF entity sends a response of the NAS message (NAS msg) to the RAN entity through an N2 message.

Step 1509: the RAN entity returns an establishment response of the control plane session through an RRC message (RRC Msg).

The present application has been described above by reference to the block diagrams and/or flow charts showing the methods, devices (systems) and/or computer program products according to the embodiments of the present application. It should be understood that one block shown in the block diagrams and/or flow charts and a combination of the blocks shown in the block diagrams and/or flow charts can be implemented by the computer program instructions. These computer program instructions can be provided to a general-purpose computer, a processor of a dedicated computer and/or another programmable data processing unit to produce a machine, so that the instructions executed by the computer processor and/or another programmable data processing unit create the methods for implementing the functions and/or actions specified in the blocks of the block diagrams and/or flow charts.

Accordingly, the present application can also be implemented by the hardware and/or software (including the firmware, resident software, microcode and the like). Further, the present application can adopt the form of computer program products on the computer usable or computer readable storage medium, which has the computer usable or computer readable program codes implemented in the medium, to be used by the instruction execution system or used in combination with the instruction execution system. In the context of the present application, the computer usable or computer readable storage medium can be any medium, which can contain, store, communicate with, transmit or transfer the programs, to be used by the instruction execution system, apparatus or device, or used in combination with the instruction execution system, apparatus or device.

1. A method for establishing a session, comprising:
receiving, by an access and mobility management function entity, a session establishment request sent by a user equipment;
determining, by the access and mobility management function entity, to establish a control plane session for the user equipment;
instructing, by the access and mobility management function entity, a session management function entity to establish the control plane session for the user equipment;
performing, by the access and mobility management function entity, data transmission with the user equipment through a Non Access Stratum, NAS, message.

2. The method of claim 1, wherein determining, by the access and mobility management function entity, to establish the control plane session for the user equipment comprises:
negotiating, by the access and mobility management function entity, with the user equipment to determine a session type to be control plane session in a registration process of the user equipment.

3. The method of claim 1, further comprising:
instructing, by the access and mobility management function entity, tunnel information of the access and mobility management function entity to the session management function entity;
wherein the tunnel information of the access and mobility management function entity is used by a user plane function entity to send downlink data to the access and mobility management function entity.

4. (canceled)

5. The method of claim 1, further comprising:
receiving, by the access and mobility management function entity, tunnel information of a user plane function entity instructed by the session management function entity;
wherein the tunnel information of the user plane function entity is used by the access and mobility management function entity to send uplink data to the user plane function entity.

6. (canceled)

7. The method of claim 5, further comprising:
receiving, by the access and mobility management function entity, service quality information of the session instructed by the session management function entity.

8. The method of claim 1, wherein performing, by the access and mobility management function entity, data transmission with the user equipment through the NAS message, comprises:
performing, by the access and mobility management function entity, data transmission with the user equipment through an NAS mobility management message; and
the method further comprises:
performing, by the access and mobility management function entity, data transmission with a user plane function entity through a tunnel.

9. (canceled)

10. The method of claim 1, wherein performing, by the access and mobility management function entity, data transmission with the user equipment through the NAS message, comprises:
performing, by the access and mobility management function entity, data transmission with the user equipment through an NAS session management message; and
the method further comprises:
performing, by the access and mobility management function entity, transmission of the NAS session management message with the session management function entity.

11. (canceled)

12. A method for establishing a session, comprising:
receiving, by a session management function entity, a session establishment request sent by a user equipment;
receiving, by the session management function entity, instruction information of establishing a control plane session for the user equipment sent by an access and mobility management function entity;
instructing, by the session management function entity, tunnel information of downlink data transmission to a user plane function entity.

13. The method of claim 12, further comprising:
receiving, by the session management function entity, tunnel information of the access and mobility management function entity sent by the access and mobility management function entity.

14. The method of claim 12, wherein the tunnel information of downlink data transmission is tunnel information of the access and mobility management function entity; or tunnel information of the session management function entity.

15. The method of claim 12, further comprising:
instructing, by the session management function entity service quality information of the session requested to be established to the access and mobility management function entity.

16. The method of claim 12, further comprising:
instructing, by the session management function entity, tunnel information of the user plane function entity to the access and mobility management function entity.

17. The method of claim 12, further comprising:
determining, by the session management function entity, a session type to be control plane session according to session context information of the user equipment.

18. The method of claim 17, further comprising:
instructing, by the session management function entity, tunnel information of the user plane function entity corresponding to the session requested to be established to the access and mobility management function entity.

19. The method of claim 12, further comprising:
performing, by the session management function entity, data transmission with the user equipment through a Non Access Stratum, NAS, session management message; and
performing, by the session management function entity, data transmission with the user plane function entity through tunnel information.

20. (canceled)

21. A method for establishing a session, comprising:
sending, by a user equipment, a session establishment request to an access and mobility management function entity;
establishing, by the user equipment, a control plane session with the access and mobility management function entity;
performing, by the user equipment, data transmission with the access and mobility management function entity through the control plane session.

22. (canceled)

23. (canceled)

24. The method of claim 21, wherein performing, by the user equipment, data transmission with the access and mobility management function entity through the control plane session comprises:
performing, by the user equipment, data transmission with the access and mobility management function entity through an NAS mobility management message or an NAS session management message.

25. (canceled)

26. An access and mobility management function entity for establishing a session, wherein the access and mobility management function entity comprises a processor, a memory and a transceiver, wherein the processor is configured to read a program in the memory to perform the method according to claim 1.

27-36. (canceled)

37. A session management function entity for establishing a session, comprising: a processor, a memory and a transceiver, wherein the processor is configured to read a program in the memory to perform the method according to claim 12.

38-45. (canceled)

46. A user equipment for establishing a session, comprising a processor, a memory and a transceiver, wherein the processor is configured to read a program in the memory to perform the method according to claim 21.

47-54. (canceled)
